(19) United States
(12) Patent Application Publication
(10) Pub. No.: US 2006/0243202 A1
(43) Pub. Date: Nov. 2, 2006

(54) Aircraft spray booth

(76) Inventor: Richard L. Thelen, Osseo, WI (US)

Correspondence Address: BARNES & THORNBURG LLP, P.O. BOX 2786, CHICAGO, IL, 60690-2786, US

(21) Appl. No.: 10/563,044

(22) PCT Filed: Jan. 6, 2004
(86) PCT No.: PCT/US04/00284

§ 371 Date: May 8, 2006

Related U.S. Application Data
(60) Provisional application No. 60/438,428, filed on Jan. 6, 2003.

(51) Int. Cl. B05B 15/12

(52) U.S. Cl. 118/326; 454/50; 118/309

(57) ABSTRACT

The invention is directed to an aircraft spray booth providing for effective removal of particulate matter, overspray and volatile organic compounds from the spray booth area without premature and uneven clogging of the filtration system. The present invention is designed to create an accelerated airflow within the plenum of the spray booth to prevent or minimize stratification of the air and reduce particulate matter fallout. The airflow through the booth is increased by the reduction of the spray booth and filter area to approximately ⅓ of the original booth width. The decrease in the cross sectional area of the spray booth increases the overall speed of the airflow and decrease the volume of air exchanged through the booth. The spray booth is tapered at the reduction area to cause acceleration of the air at the sidewalls. The acceleration of air at the sidewalls causes a purging of air along the sidewalls and prevents paint and other particulate matter from adhering to the sidewalls. The reduction in the spray booth allows lighting can be placed closer to the painted surface in the tail and fuselage section of the aircraft to aid in the accuracy of the painting process.

This application claims the benefit of U.S. Provisional Application No. 60/438,428 filed Jan. 6, 2003.

### BACKGROUND OF THE INVENTION

The present invention relates to spray booths that are used to enclose dangerous activities, such as painting and stripping, that are performed therein, and to contain the risk of fire. Spray booths are also used to control the overspray from spray paint guns and capture the paint particles that are not applied to the object being painted. Spray booths are designed in accordance with local and national electrical and fire codes' and are typically fabricated in a single or double wall construction.

Spray booths typically include a filter section that is comprised of a set of filter racks, a plenum and a set of filters. Airflow created by a fan places the plenum under negative pressure. The fan ejects the cleaned air to the atmosphere. Airflow through a spray booth is an important design consideration. Desired airflow through the spray booth is typically at a constant 100 fpm from the intake end of the booth to the exhaust end. In the conventional design, the cross sectional area of the spray booth is constant from entrance to exhaust. Prior art spray booths are adequate for spraying automobiles but are inadequate for spraying aircraft since premature filter clogging occurs on the filters near the center of the filter banks since the majority of the paintwork occurs near the centerline of the booth.

In view of the above, it should be appreciated that there is a need for a spray booth that is designed to prevent premature clogging of the filter system when spraying aircraft. The present disclosure satisfies these and other needs and provides further related advantages.

### SUMMARY OF THE INVENTION

The disclosed aircraft spray booth provides for effective removal of particulate matter, overspray and volatile organic compounds from the spray booth area without premature and uneven clogging of the filtration system. The aircraft spray booth is designed to create an accelerated airflow within the plenum of the booth to prevent or minimize stratification of the air and reduce particulate matter fallout. The airflow through the booth is increased by the reduction of the filter area to approximately the width of the aircraft fuselage, which is typically ⅓ of the booth width. To compensate for the lack of filtration on the sides of the reduction area, the booth is tapered at the reduction area to cause acceleration of the air at the sidewalls. The acceleration of air at the sidewalls causes a purging of air along the sidewalls and prevents paint and other particulate matter from adhering to the sidewalls.

The aircraft spray booth may be used with dry filter banks from 1 to 3 stages, water wash air cleaning and with carbon adsorption filter cells. The aircraft spray booth may also be used with draw-through and forced air style air intakes. Since the walls of the spray booth are closer to the fuselage of the aircraft, lighting can be placed closer to the painted surface in the tail section of the aircraft to aid in the accuracy of the painting process.

Other features and advantages of the disclosure will be set forth in part in the description which follows and the accompanying drawings, wherein the embodiments of the disclosure are described and shown, and in part will become apparent upon examination of the following detailed description taken in conjunction with the accompanying drawings.

### BRIEF DESCRIPTION OF THE DRAWINGS

FIG. 1 is a plan view of the open front aircraft spray booth of the present invention;

FIG. 2 is a side elevational view of the open front aircraft spray booth;

FIG. 3 is a plan view of the aircraft spray booth with solid doors and a filtered plenum;

FIG. 4 is a side elevational view of the aircraft spray booth with solid doors and a filter chamber;

FIG. 5 is a plan view of the aircraft spray booth with filtered doors; and

FIG. 6 is a side elevational view of the aircraft spray booth with filtered doors.

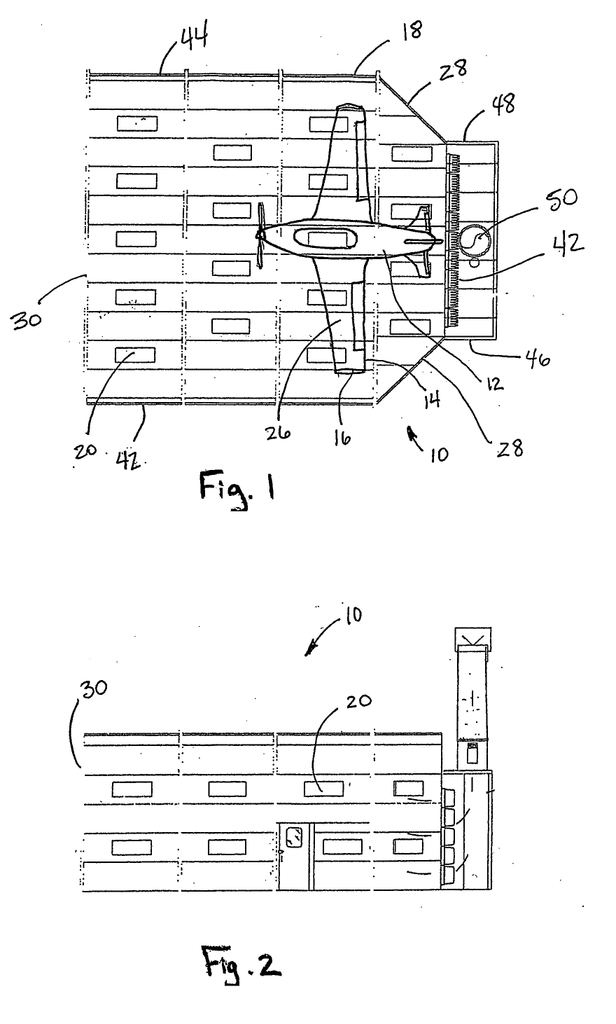

### DETAILED DESCRIPTION OF THE INVENTION

For the purpose of promoting an understanding of the principles of the invention, references will be made to the embodiments illustrated in the drawings. Specific language will also be used to describe the same. It will, nevertheless, be understood that no limitation of the scope of the invention is thereby intended, such alterations and further modifications in the illustrated device, and such further applications of the principles of the invention illustrated herein being contemplated as would normally occur to one skilled in the art to which the invention relates.

The present invention is directed to a cross draft spray booth 10 for aircraft 12 that has advanced airflow characteristics to allow for the enhanced capture of contaminants associated with painting aircraft. Airflow through the aircraft spray booth is enhanced by the dimensional layout of the booth. The cross sectional area of the spray booth is not a constant dimension, but varies, tapering near the rearward edge 14 of the wingtips 16 to the exhaust end of the booth. In large conventional aviation spray booths, air within the booth typically stratifies from changes in air density due to variations in ambient air temperature and the addition of paint and solvents to the air stream. Heat generated by the spray work or stripping activities performed in the spray booth significantly changes the air density and causes stratification to occur. Stratification of the air within the spray booth is undesirable because concentrations of volatile organic compounds (VOCs) or particulate matter (PM) can accumulate within the booth reaching the lower explosion limit (LEL), creating the risk of fire or a devastating and life threatening explosion. In the aircraft spray booth 10 of the present invention, the air passing through the spray booth 10 is accelerated to prevent or minimize stratification. To achieve the acceleration, the walls 18 of the booth taper from behind the wingtips 16 to the exhaust end. The tapering of the spray booth causes the airflow to accelerate from the intake to the exhaust end of the spray booth. The width of the spray booth is reduce by the tapered walls 18 to approximately ½ to ⅔ of the width of the opening of the spray booth. The tapered walls 18 will cause the air velocity within the booth 10 to increase; preferably more than double from the intake end to exhaust end.

Lighting 20 positioned within the spray booth 10 prevents shadows from occurring on the work surface. To properly paint an aircraft or any object for that matter, lighting 20 must be used to ensure that a quality holiday and blemish free finish is applied to the aircraft. The presence of shadows on the work surface may conceal unpainted areas of the aircraft from the painter causing the painter to miss those areas, which would require expensive and time consuming repair work. Lighting 20 is positioned in the walls 18 and ceiling 22 of the spray booth 10. The presence of shadows is especially common when painting aircraft since the lights in the side walls 18 of the spray booth 10 are located at the rearward edges 14 of the wing tips 16 and not near the fuselage 24 of the aircraft. Tapering the walls 18 of the spray booth 10 after the wing 26 allows the lighting to be positioned closer to the fuselage 24, eliminating shadows. Additional lighting 20 can be placed on the transitional section 28 of the walls, casting light in a forward angular direction, illuminating the wings 26.

There are two basic types of spray booths, cross draft and downdraft. In cross draft spray booths the airflow through the spray booth is horizontal. In downdraft spray booths the airflow through the booth moves from the ceiling to a filter installed in the floor of the booth. The spray booth 10 of the present invention is a cross draft spray booth 10.

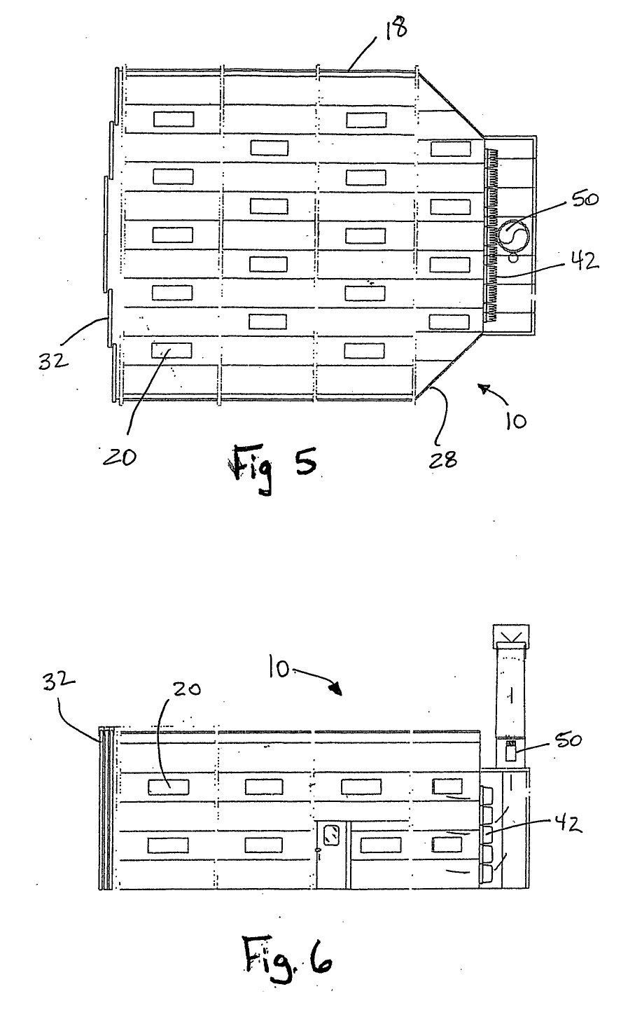

There are two methods of introducing fresh intake air into the spray booths, the draw through method and the forced air method. In the draw-through spray booth, air enters the painting environment through either the end wall 30 of the booth 10, which can be open, or equipped with one or more filter doors 32. The booth utilizing the filter chamber 36 is equipped with solid doors 37. The filter doors 32, as shown in FIG. 5, consist of doors frames equipped with filter racks and filters in lieu of solid walls. Spray booths 10 with filter doors have the advantage of controlling the quality of air entering the booth. The filter doors 32 capture particulate matter that may blemish the paint finish on the aircraft during painting if not removed from the air. The open front style of spray booth is only used where cleanliness is of moderate concern or the quantity of particulate matter in the airspace surrounding the spray booth is light.

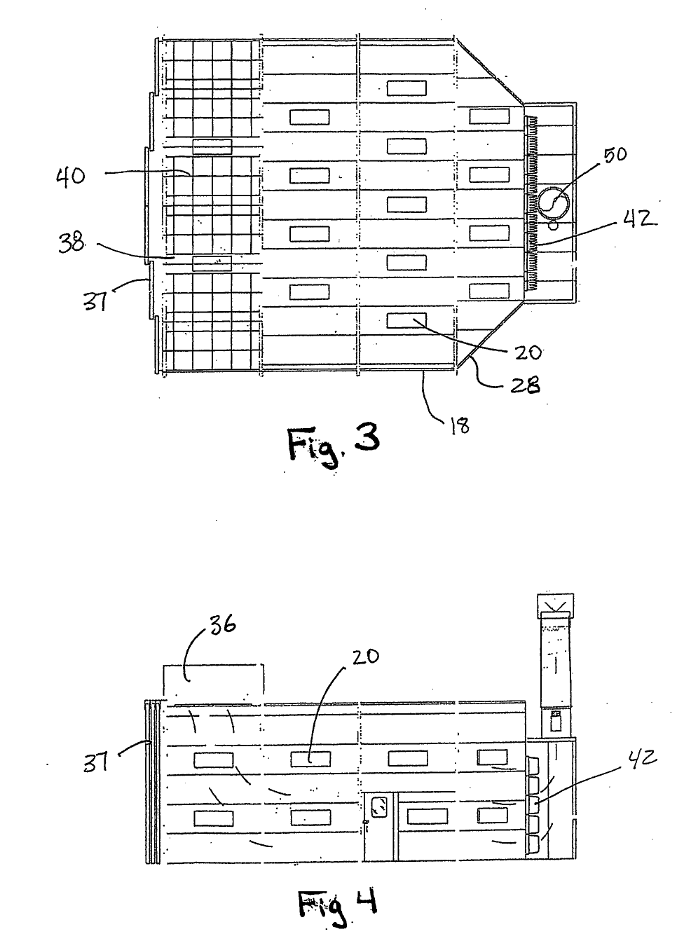

In the forced air style of spray booth, the intake air is forced into the booth through an intake air chamber. The intake air chamber consists of a filter chamber 36, filter racks 38 and filters 40 as shown in FIGS. 3 and 4. The forced air style of spray booth is advantageous in that the incoming air may be pre-cleaned in the fan unit with one or two stages of filters and then cleaned once again at the intake chamber. The forced air style of spray booth assures the painter the best possible air quality entering the spray booth.

The spray booth 10 is equipped with a fire protection system that may be in the form of dry chemical, foam or water based or a combination thereof. The spray booth 10 is designed to support the fire protection system as well as the rest of the enclosure itself. Structural design of the spray booth is as important as the design of the lighting, filtration and movement of air through the booth.

In a typical aircraft paint/strip booth, approximately ⅔rds of the surface area of the aircraft to be painted is positioned over the center portion of the spray booth. Because ⅔rds of the aircraft lies in the center of the booth, the center filters of the filter bank 42 of the conventional dry filter spray booth become more loaded with particulate matter and overspray than the filters that are located on the perimeter of the filter bank 42. This causes premature failure of the filters located at the center of the booth.

The aircraft spray booth 10 is most effective where moderate quantities of paint are applied and where the internal volume of the spray booth is large. The spray booth 10 is designed to maintain the solvent concentration well below the Lower Explosive Limit (LEL) and minimize the toxic effect of the volatile organic compounds (VOCs) within the spray booth 10. Current codes for spray booths allow an LEL up to 25%. Typical use of the spray booth of the present invention maintain the LEL below 5%.

The cross-draft aircraft spray booth 10 of the present invention comprises the end wall 30 that may be open or designed with a plurality of doors 32. The sidewalls 18 are made up of segments. First and second sidewall segments 42 and 44 are adjacent to the end wall 30 and are spaced apart to allow for the passage of an aircraft. The sidewalls 18 further include a third and fourth sidewall segments 46 and 48 that are adjacent to the first and second sidewall segments 42 and 44. The third and fourth sidewall segments 46 and 48 are stepped inward from the first and second sidewall segments 42 and 44, closer to the centerline of the spray booth 10. The first and second sidewall segments 42 and 44 are connected to the third and forth sidewall segments by the transition sections 28. A bank of filters 42 oppose the end wall 30 and are used to capture paint overspray. An electric fan unit 50 is positioned downstream from the bank of filters 42 and is adapted to create an airflow through the spray booth 10.

When painting an aircraft, several painters working simultaneously are required to properly coat an aircraft. The quantity of paint and VOCs causes stratification of the air to occur creating health and safety hazards. The enhanced airflow characteristics of the spray booth 10 of the present invention prevents stratification from occurring and eliminates buildup of solvent concentrations in localized portions of the spray booth by quickly exchanging the air within the spray booth.

The spray booth 10 of the present invention provides for a superior paint finish on the aircraft due to the acceleration of airflow and continued suspension of paint particles from the point of release to the filter chamber 36. Fewer particles will drop out of suspension in the air stream reducing or eliminating blemishes. Blemishes that occur in prior conventional spray booths must be rubbed or sanded out and then re-painted at great expense and loss of productivity.

The spray booth 10 of the present invention reduces operating costs by decreasing the total volume of air required to keep overspray and VOCs to desired levels. The air within the spray booth is constantly being exchanged with air from outside of the spray booth. In most geographical areas, during the winter months, the exchanged air requires the addition of heat to the air stream to ensure that incoming air is warmed to a temperature as required by the paint manufacturer or for the comfort of the painter. Improper air temperature within the spray booth can cause problems with the application of the paint. Air temperatures outside of the range specified by the paint manufacture can cause improper adhesion, drying problems and paint imperfections, such as fish eyes. By reducing the volume of airflow through the spray booth in half over the conventional design, heat required to warm the incoming air is greatly reduced.

The spray booth of the present invention reduces the cost and reoccurrence of filter change-outs since fewer filters are required than in the conventional spray booths and filter loading is more uniform across the filters. In conventional spray booths, a silhouette of the aircraft composed of paint overspray will typically appear on the filters 42, with paint loading being heaviest in the center and light along the perimeter. The uneven filter loading requires premature replacement of the filters 42 and leads to unnecessary filter clogging. The aircraft spray booth 10 of the present invention is designed so that the paint filters 42 load evenly, preventing premature filter clogging.

Capital costs with regards to installing the spray booth 10 of the present invention are greatly reduced over the conventional design since the footprint for the spray booth is significantly smaller. Fire-protection equipment costs associated with the spray booth 10 are also reduced because the smaller footprint. Using the spray booth design of the present invention, up to four 10 spray booths may be clustered together a radial manner to allow for simultaneous painting and stripping of four planes in a much smaller space than required utilizing the conventional design.

The reduction in total air volume passing through the spray booth 10 also reduces the costs associated with removing fumes and VOCs. Removal of VOCs is traditionally accomplished by using expensive emission control equipment, which includes carbon absorption and/or thermal oxidizer devices. The size and costs of the emission control equipment is directly related to the volume of air to be cleaned. The reduction in total overall air volume greatly decreases the cost of emission equipment need and reduces the overall operational costs.

Various features of the invention have been particularly shown and described in connection with the illustrated embodiment of the invention, however, it must be understood that these particular arrangements merely illustrate, and that the invention is to be given its fullest interpretation within the terms of the appended claims.

What is claimed is:

1. A cross-draft aircraft spray booth for aircraft painting and stripping comprising:
an end wall having an opening, said opening adapted to allow the ingress and egress of the aircraft;
a first side wall segment, adjacent to said end wall;
a second side wall segment, opposing said first side wall segment;
a third side wall segment adjacent to said first sidewall segment, said third sidewall segment is stepped inward from said first sidewall segment;
a fourth sidewall segment adjacent to said second sidewall segment, said fourth sidewall segment being stepped inward from said second sidewall segment and opposing said third sidewall segment;
a first transitional sidewall segment positioned between said first sidewall segment and said third sidewall segment;
a second transitional sidewall segment positioned between said second sidewall segment and said fourth sidewall segment;
a filtration unit opposing said end wall, said filtration unit adapted to capture paint overspray; and
a fan unit positioned downstream from said bank of filters, said fan unit adapted to create an airflow through said spray booth.

2. The cross-draft spray booth of claim 1, further including:
a carbon filter bank and a fume oxidizer to remove VOC's and odors.

3. The cross-draft spray booth of claim 1, further including a recirculating air system.

4. The cross-draft spray booth of claim 1, wherein heated air is provided within said booth to cure the paint of a recently painted object.

5. The cross-draft spray booth of claim 1, wherein the first wall segment includes lighting to illuminate the aircraft.

6. The cross-draft spray booth of claim 1, wherein the second wall segment includes lighting to illuminate an aircraft.

7. The cross-draft spray booth of claim 1, wherein the width between the third and fourth side walls is from about ½ to about ⅔rds less than the width between the first and second side walls.

8. The cross-draft spray booth of claim 1, wherein the end wall includes a plurality of doors adapted to enclose the aircraft within the spray booth.

9. An aircraft contamination collection booth for aircraft comprising:
an entryway adapted to permit the ingress and egress of aircraft;
an airflow generation unit adapted to move air through the booth;
an end wall, opposing the entryway, the end wall including a filtration system adapted to remove airborne contaminates;
the booth having sidewalls formed to have a first section with a first width and a second section with a second width wherein the first width is approximately ⅔rds greater than the second width such that the airflow rate in the second width is greater than the airflow rate of the first width.

10. The aircraft contamination collection booth of claim 9, wherein the entryway includes doors adapted to seal the entryway to the booth.

11. The aircraft contamination collection booth of claim 9, wherein the filtration system includes a plurality of removable filtration units.

12. The aircraft contamination collection booth of claim 9, wherein the sidewalls include a plurality of lights adapted to illuminate the aircraft.

13. The aircraft contamination collection booth of claim 9; wherein the booth includes an air intake to permit air to enter the booth.

14. The aircraft contamination collection booth of claim 9, wherein the side walls include a tapered section to transition from the first section to the second section.

15. An aircraft contamination collection booth for aircraft comprising:
an entryway having an opening adapted to permit the ingress and egress of the aircraft;
an end wall opposing the entryway, the end wall including a filtration system;
a fan adapted to create a continuous airflow through the booth;
a first sidewall segment, positioned adjacent the entryway;
a second sidewall segment, opposing the first sidewall segment;
a first tapered wall segment adjacent to the first sidewall segment at a first end and adjacent to the end wall at a second end;
a second tapered wall segment adjacent to the second sidewall segment at a first end and adjacent to the end wall at a second end.

16. The aircraft contamination collection booth of claim 15, further including:
a carbon filter bank and a fume oxidizer to remove VOC's and odors.

17. The aircraft contamination collection booth of claim 15, farther including a recirculating air system.

18. The aircraft contamination collection booth of claim 15, wherein heated air is provided within said booth to cure the paint of a recently painted aircraft.

19. The aircraft contamination collection booth of claim 15, wherein the first wall segment includes lighting to illuminate the aircraft.

20. The aircraft contamination collection booth of claim 15, wherein the second wall segment includes lighting to illuminate an aircraft.

21. The aircraft contamination collection booth of claim 15, wherein the width of the booth after the first and second tapered wall segments is reduced by about ⅔rds.

22. The aircraft contamination collection booth of claim 15, wherein the end wall includes a doors adapted to enclose the aircraft within the booth.
